(19) United States
(12) Patent Application Publication
(10) Pub. No.: US 2013/0100266 A1
(43) Pub. Date: Apr. 25, 2013

(54) METHOD AND APPARATUS FOR DETERMINATION OF OBJECT TOPOLOGY

(71) Applicant: Kenneth Edward Salsman, Pleasanton, CA (US)

(72) Inventor: Kenneth Edward Salsman, Pleasanton, CA (US)

(21) Appl. No.: 13/469,051

(22) Filed: May 10, 2012

Related U.S. Application Data
(60) Provisional application No. 61/551,105, filed on Oct. 25, 2011.

(51) Int. Cl. H04N 7/18

(52) U.S. Cl. 348/77; 348/E07.085

(57) ABSTRACT

Electronic devices may include imaging systems with camera modules and light sources. A camera module may be used to capture images while operating one or more light sources. Operating the light sources may generate changing illumination patterns on surfaces of objects to be imaged. Images of an object may be captured under one or more different illumination conditions generated using the light sources. Shadow patterns in the captured images may change from one image captured under one illumination condition to another image captured under a different illumination condition. The electronic device may detect changes in the shadow patterns between multiple captured images. The detected changes in shadow patterns may be used to determine whether an object in an image is a planar object or an object having protruding features. A user authentication system in the device may permit or deny access to the device based, in part, on that determination.

This application claims the benefit of provisional patent application No. 61/551,105, filed Oct. 25, 2011, which is hereby incorporated by reference herein in its entirety.

### BACKGROUND

This relates generally to electronic devices, and more particularly, to electronic devices having camera modules for object recognition, depth mapping, and imaging operations.

Electronic devices such as computers, tablet computers, laptop computers and cellular telephones often include camera modules with image sensors for capturing images. Some devices include security systems that use the camera module to capture an image of a user of the device and verify that the user is an authorized user by matching facial features of the user in the captured image facial features of authorized users.

Typical devices perform this type of facial recognition security verification operation using a single camera module. However, a captured image of a photograph of an authorized user can contain nearly the same image data as a captured image of the face of the authorized user. For this reason, a two-dimensional photograph of an authorized users face can sometimes be used to fool a conventional facial recognition security system and allow an unauthorized user to gain access to the device.

It would therefore be desirable to be able to provide improved electronic devices with improved imaging systems for object recognition.

### BRIEF DESCRIPTION OF THE DRAWINGS

FIG. 1 is a diagram of an illustrative electronic device having a camera module and light sources in accordance with an embodiment of the present invention.

FIG. 2 is an illustrative diagram showing how a camera module in an electronic device may view illuminated portions and shaded portions of an object that is illuminated using a light source in the electronic device in accordance with an embodiment of the present invention.

FIG. 3 is an illustrative diagram showing how a camera module in an electronic device of the type shown in FIG. 2 may view different illuminated portions and different shaded portions of an object that is illuminated using a different light source in the electronic device in accordance with an embodiment of the present invention.

FIG. 4 is an illustrative diagram showing how shaded portions of an object that is illuminated by an ambient light source may be illuminated using a light source in the electronic device in accordance with an embodiment of the present invention.

FIG. 5 is an illustrative diagram showing how a camera module in an electronic device may view changing illumination patterns on surfaces of an object that is illuminated using multiple light sources in the electronic device in accordance with an embodiment of the present invention.

FIG. 6 is a flowchart of illustrative steps involved in gathering topological image data in accordance with an embodiment of the present invention.

FIG. 7 is a flowchart of illustrative steps involved in performing facial recognition security verification operations using an electronic device with a facial recognition security system that includes a camera module and a light source in accordance with an embodiment of the present invention.

### DETAILED DESCRIPTION

Digital camera modules are widely used in electronic devices such as digital cameras, computers, cellular telephones, and other electronic devices. These electronic devices may include image sensors that gather incoming light to capture an image. The image sensors may include arrays of image pixels. The pixels in the image sensors may include photosensitive elements such as photodiodes that convert the incoming light into digital data. Image sensors may have any number of pixels (e.g., hundreds or thousands or more). A typical image sensor may, for example, have hundreds, thousands, or millions of pixels (e.g., megapixels).

In some devices, camera modules may be used to capture images to be used in security verification operations for the device. For example, in order to verify that a user of a device is authorized to access the device, an image of the users face may be captured using the camera module and compared with one or more database images of faces of authorized users. Light sources in the electronic device may be used to alter the illumination of an object such as a users face to be imaged during image capture operations. In this way, changes in shadow patterns in captured images due to changing illumination patterns on the surface of the object may be used to verify that the object is a three-dimensional object prior to performing additional image analysis operations such as facial recognition operations or topology mapping of the object.

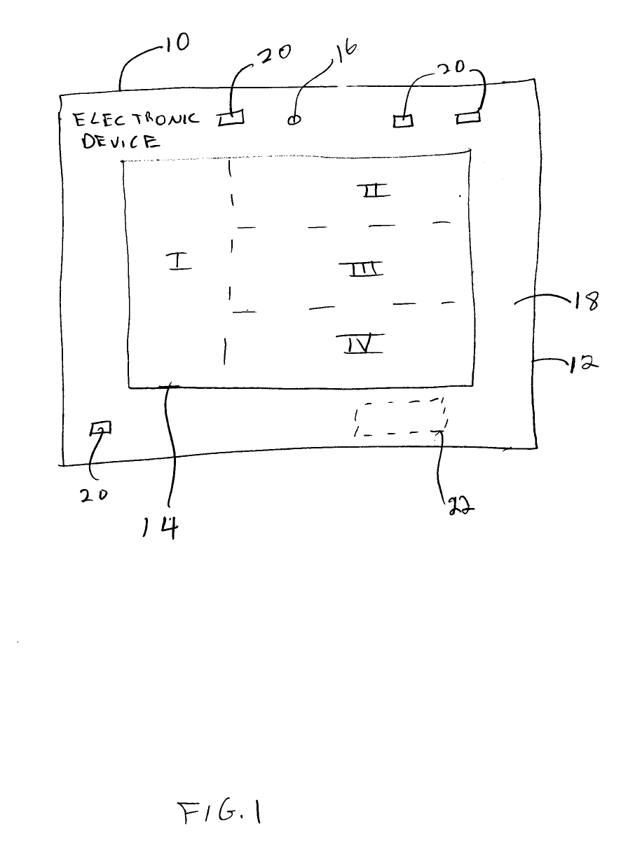

FIG. 1 is a diagram of an illustrative electronic device that uses a camera module and one or more light sources to capture images. Electronic device 10 of FIG. 1 may be a portable electronic device such as a camera, a cellular telephone, a video camera, or may be a larger electronic device such as a tablet computer, a laptop computer, a display for a desktop computer, a display for an automatic bank teller machine, a security gate for providing authenticated access to a controlled location, or other imaging device that captures digital image data.

Electronic device 10 may include a housing structure such as housing 12. Housing 12 may include openings for accommodating electronic components such as display 14, camera module 16, and one or more light sources 20. If desired, housing 12 of device 10 may include a bezel portion 18 that surrounds display 14. Camera module 16 and light sources 20 may be mounted behind openings in bezel portion 18 of housing 12. If desired, camera module 16, light sources 20, display 14, and/or control circuitry such as circuitry 22 may, in combination, form a security verification system such as a facial recognition security verification system for device 10.

Camera module 16 may be used to convert incoming light into digital image data. Camera module 16 may include one or more lenses and one or more corresponding image sensors. During image capture operations, light from a scene may be focused onto image sensors using respective lenses in camera module 16. Image sensors in camera module 16 may include color filters such as red color filters, blue color filters, green color filters, near-infrared color filters, Bayer pattern color filters or other color filters for capturing color images and/or infrared images of an object or a scene. Lenses and image sensors in camera module 16 may be mounted in a common package and may provide image data to control circuitry 22.

Circuitry 22 may include one or more integrated circuits (e.g., image processing circuits, microprocessors, storage devices such as random-access memory and non-volatile memory, etc.) and may be implemented using components that are separate from camera module 16 and/or that form part of camera module 16. Image data that has been captured by camera module 16 may be processed and stored using processing circuitry 22. Processed image data may, if desired, be provided to external equipment (e.g., a computer or other device) using wired and/or wireless communications paths coupled to circuitry 22.

Circuitry 22 may be used in operating camera module 12, display 14, light sources 20 or other components such as keyboards, audio ports, speakers, or other components for device 10. Light sources 20 may include light sources such as lamps, light-emitting diodes, lasers, or other sources of light. Each light source 20 may be a white light source or may contain one or more light-generating elements that emit different colors of light. For example, light-source 20 may contain multiple light-emitting diodes of different colors or may contain white-light light-emitting diodes or other white light sources that are provided with different respective colored filters. In response to control signals from circuitry 22, each light source 20 may produce light of a desired color and intensity. If desired, light sources 20 may include an infrared light source configured to emit near-infrared light that is invisible to the eye of a user of device 10. In this way, one or more invisible flashes of infrared light may be used to illuminate the face of a user of device 10 while one or more image sensors in camera module 16 is used to capture infrared images of the users face (e.g., for security verification operations).

Circuitry 22 may generate control signals for operating camera module 16 and one or more light sources such as light sources 20 during imaging operations. Light sources 20 may be positioned at various positions with respect to camera module 16 in, for example, bezel region 18. Camera module 16 may be used to capture one or more images of an object while each light source 20 is turned on (e.g., while an object within the field of view of camera module 16 is illuminated by each light source 20). For example, a first image of an object may be captured without any light source 20 turned on, a second image of the object may be captured while a first one of light sources 20 is turned on, and a third image may be captured while a second one of light sources 20 is turned on. However, this is merely illustrative. If desired, one or more images may be captured while two or more of light sources 20 are turned on.

If desired, circuitry 22 may generate control signals for operating one or more portions of display 14 such as portions I, II, III, and/or IV during imaging operations for security verification or depth mapping operations. Display 14 may include an array of display pixels. Operating a portion of display 14 may include operating a selected portion of the display pixels in display 14 while deactivating other display pixels in display 14. In this way, display 14 may be used as a positionable light source for illuminating an object in the field of view of camera module 16 during imaging operations.

For example, a first image may be captured without any light source 20 turned on and with all regions I, II, III, and IV of display 14 turned on, a second image may be captured without any light source 20 turned on and with regions II, III, and IV of display 14 turned off and region I of display 14 turned on, and a third image may be captured without any light source 20 turned on and with regions I, II, and IV of display 14 turned off and region III of display 14 turned on. However, these combinations are merely illustrative. If desired, images may be captured using camera module 16 while each one of regions I, II, III, and IV is turned on, images may be captured while operating more than four regions of display 14, images may be captured while operating less than four regions of display 14, or images may be captured while operating any desired sequence of light sources that include portions of display 14 and light sources 20.

Images of an object that are captured while the object is illuminated by various combinations of light sources 20 and regions of display 14 may be processed and compared to extract topological (depth) information from the images. For example, depth information associated with the distance of object surfaces in an image from device 10 may be extracted from images of the objects under illumination from different angles. This is because light that is incident on an a three-dimensional object from one angle will generate shadows of differing size and darkness than light that is incident on that object from another angle. If desired, extracted topological information may be used to generate a depth image (e.g., an image of the scene that includes information associated with the distance of object surfaces in an image from device 10).

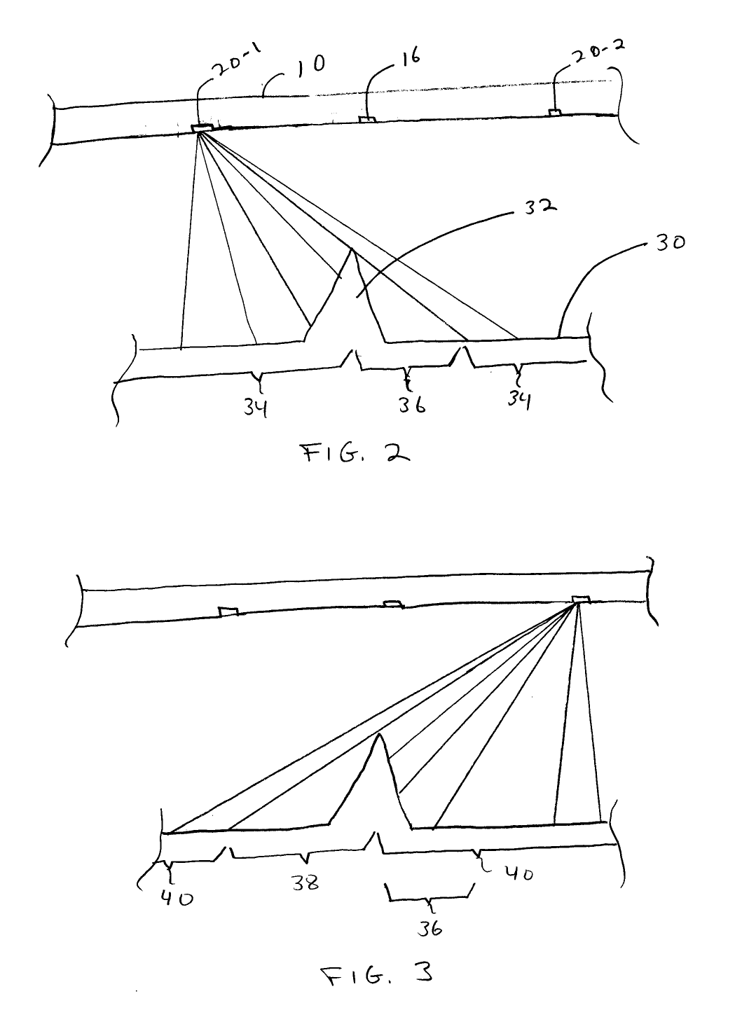

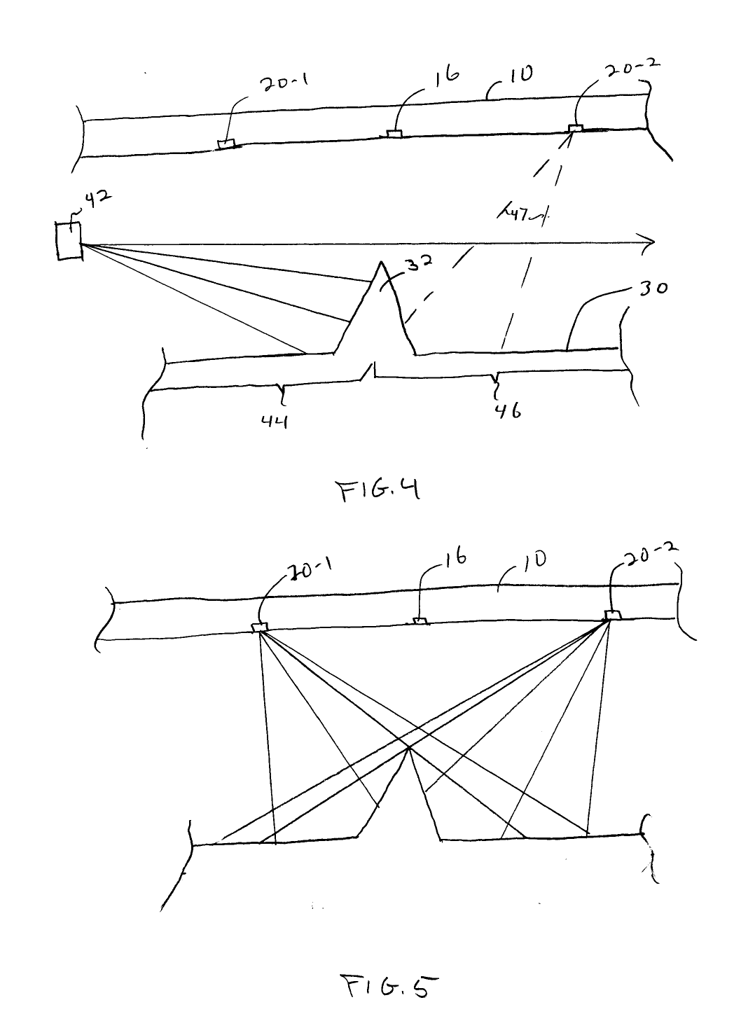

As shown in FIGS. 2 and 3, changes in shadow patterns in captured images of an object captured while the object is under illumination from at least two different angles can help determine whether the object is a three-dimensional object (e.g., an object with one or more protruding features or an object with a curved surface) or a two-dimensional object (e.g., a planar object without protruding features).

In the examples of FIGS. 2 and 3, device 10 includes first and second light sources 20-1 and 20-2 and camera module 16 and may be used to capture images of object 30 having a feature 32. For example, object 30 may be a portion of a human face. Feature 32 may be a protrusion such as a nose.

In the configuration of FIG. 2, light source 20-1 may be turned on (e.g., flashed, pulsed or switched on) and light source 20-2 may be turned off while an image of object 30 is captured. While light source 20-1 is on, object 30 may be illuminated such that some portions such as illuminated portions 34 are illuminated and other portions such as shaded portion 36 are in shadow, thereby generating relatively light and dark portions in the captured image.

In the configuration of FIG. 3, light source 20-2 may be turned on (e.g., flashed, pulsed or switched on) and light source 20-1 may be turned off while another image of object 30 is captured. While light source 20-2 is on, object 30 may be illuminated such that shaded portion 36 of FIG. 2 is illuminated along with illuminated portions such as illuminated portions 40 and different portions of object 30 such as shaded portion 38 are in shadow. In this way, changes in shadow patterns between images of an object such as a human face captured under illumination from at least two different angles can help determine whether the image of the human face is an image of a three-dimensional human face or a two-dimensional photograph of that human face.

Providing device 10 with one or more light sources (e.g., light sources 20 and/or portions of display 14) that can be flashed or turned on for one or more image captures and then turned off for another set of one or more image captures may help provide device 10 with the ability to determine the topological structure of an object being imaged. However, the examples of FIGS. 2, and 3 are merely illustrative. If desired, first and second images may be captured while some or all of display 14 is used to illuminate the object, or images may be captured while other sources of light are used to illuminate the object.

If desired, a first image of an object may be captured while the object is under ambient light conditions and combined with images captured while using light sources 20 and/or display 14 to illuminate the object as shown in FIG. 4. In the example of FIG. 4, object 30 is illuminated by ambient light source 42 (e.g., sunlight or fluorescent or incandescent lamps in a room). Ambient light source 42 produces a specific shadow structure on the three-dimensional topology or shape of object 30 such that object 30 includes illuminated portions such as illuminated portion 44 and shadow portions such as shaded portion 46. For example, the nose or eye socket of a human face may form a natural protrusion that will generate a shadow on an adjacent portion of the face based on the direction of the majority of the ambient light. A captured image of object 30 under these ambient lighting conditions will therefore include a particular shadow pattern.

As indicated by dashed lines 47, one or more light sources such as light source 20-2 (and/or portions of display 14) may generate illumination conditions that are different than those generated by the ambient light on object 30 and shaded portion 46 may be either brightened or shifted in position by the light from light source 20-2 (for example). A captured image of object 30 with light source 20-2 turned on will therefore include a shadow pattern that is different than the shadow pattern in the captured image of object 30 under ambient lighting conditions.

In the case of a two-dimensional photograph of an object having no protruding features or curved or bent surfaces, apparent shadow patterns (e.g., shadows in a photograph) cannot change due to a change in the lighting conditions generated by device 10 and the system can determine, in response to the lack of change in detected shadow patterns in capture images, that the object is a two-dimensional rather than a three-dimensional object.

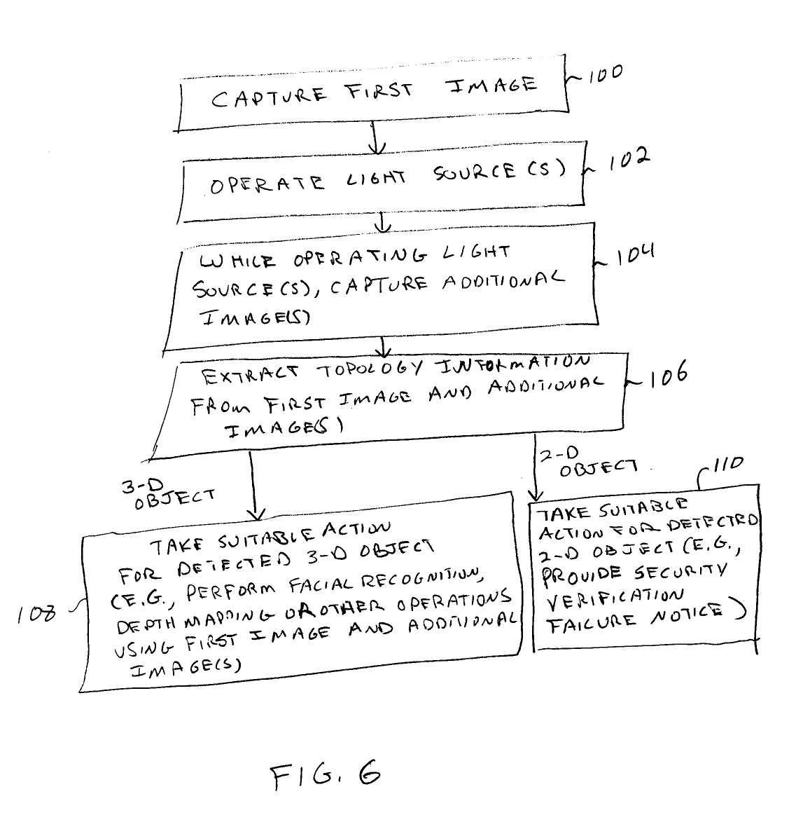

If desired, during image capture operations, more than one light source 20 may be operated as shown in FIG. 5. In the example of FIG. 5, one or more images may be captured using camera module 16 while light sources 20-1 and 20-2 are both in operation. In this way, an image may be captured in which substantially all of object 30 is illuminated and shadow portions such as shaded portions, 36, 38, and 46 of FIGS. 2, 3, and 4 respectively may be brightened or eliminated. An image captured while light sources 20-1 and 20-2 are both in operation may therefore include a different shadow pattern than an image captured with one or both of light sources 20-1 and 20-2 are turned off.

The image capture operations described above in connection with FIGS. 2, 3, and 4 may be used as a portion of a security verification operation for a security system that uses facial recognition in images as a user authentication tool. If desired, prior to performing facial recognition operations on captured images, a system such as device 10 may first determine whether the face being imaged is a two-dimensional photograph of a face or a three-dimensional face.

This type of three-dimensional verification (or three-dimensional topological mapping) operation may be performed by capturing images while generating extremely short flashes of visible light or near-infrared light, thereby minimizing the light perceived by the person being imaged. In the case of a near-infrared light flash, a user may not perceive the flash at all.

If desired, circuitry 22 (FIG. 1) may be configured to extract shadow information such as relative heights and darknesses of shadows that are produced on an object from images of the object captured with differing illumination angles with respect to the objects surface. The extracted shadow information may be combined with the known relative positions of light sources 20 to extract depth information such as the topological structure of the object from the captured images.

In order to generate a full depth map of an object using a single camera, shadow information may be extracted from images captured while illuminating the object from at least two illumination angles and compared. The observed change in, for example, the height of a particular shadow between an image captured with one light source at a first known position and another light source at another known position can be used to calculate depth information such as the distance of that portion of the object from the two light sources.

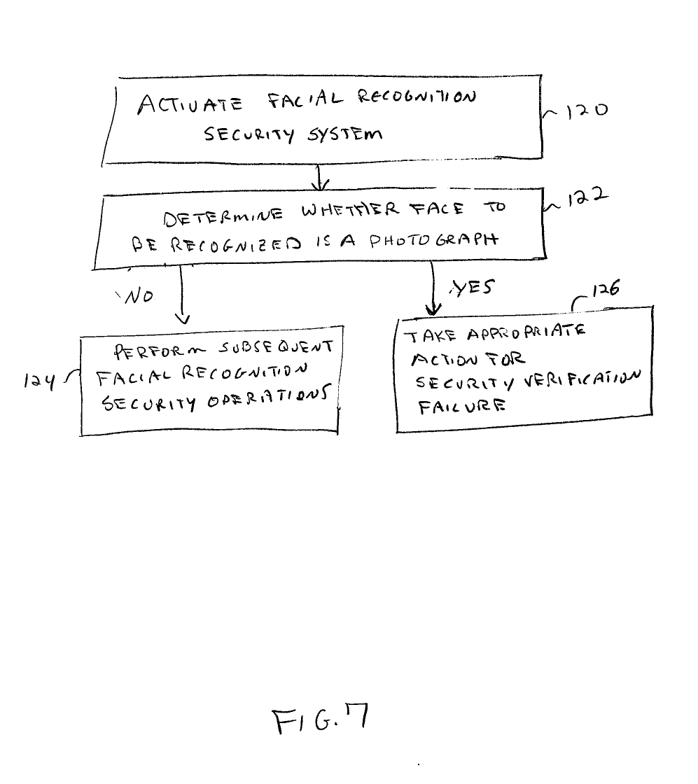

FIG. 6 is a flowchart showing illustrative steps involved in obtaining and using topological information using an electronic device having a camera module and a light source.

At step 100, a camera module such as camera module 16 of device 10 (see, e.g., FIG. 1) may be used to capture a first image. The first captured image may contain images of one or more objects in a scene.

At step 102, one or more light sources such as light sources 20 and/or portions I, II, III, IV or other portions of a display may be operated (e.g., turned on, flashed, or pulsed).

At step 104, while operating the light sources, one or more additional images may be captured. Capturing additional images while operating the light sources may include capturing a single additional image while operating a single light source, capturing a single image while operating multiple light sources, capturing multiple images while operating multiple light sources or capturing multiple images while operating a single light source.

At step 106, depth (topology) information associated with objects in the captured images (e.g., depth information, shadow height information, or shadow pattern change information) may be extracted from the first image and one or more additional captured images. The topology information may be extracted by comparing the first image with one or more additional images captured while operating the light source(s). The extracted topology information may be used to determine whether an imaged object is a two-dimensional object (i.e., a planar object such as a photograph) or a three-dimensional object such as a face of a human or animal (e.g., by determining whether shaded portions of an object are different between multiple images).

At step 108, in response to determining that an object in a captured image is a three-dimensional object, suitable action may be taken for a detected three-dimensional object. Suitable action for a detected three-dimensional object may include performing security verification operations such as facial recognition operations using the first image and/or the additional captured images, performing depth mapping operations such as generating a topological map using the first image and the additional captured images, performing additional security verification operations (e.g., finger print security verification operations, pass-code entry security verification operations or other supplemental security verification operations), or performing other operations using the first image and the additional captured images.

For example, performing facial recognition operations may include performing transformations of images, performing a principal component analysis of one or more images, performing a linear discriminant analysis of one or more images, comparing a captured image of a face with an image of a face or image information associated with facial information associated with authorized users of the device that is stored on the device (e.g., stored using circuitry 22 of FIG. 1) or otherwise determining whether a face in a captured image is the face of an authorized user of the device. However, performing facial recognition operations in response to detecting that an imaged object is a three-dimensional image is merely illustrative. If desired, a depth image such as a topological map may be generated using the first image and the additional captured images.

Extracted topology information from the images may be used to generate a depth image such as a topological map of a scene (e.g., by combining extracted information associated with changes in shadow height differences between multiple images with information about the relative locations of the operated light sources used while capturing the images).

At step 110, in response to determining that an object in a captured image is a two-dimensional object, suitable action may be taken for a detected two-dimensional object. Suitable action for a detected two-dimensional object may include providing a security verification failure notice using a display such as display 14, locking the electronic device, or terminating topological mapping operations.

FIG. 7 is a flowchart showing illustrative steps involved in authenticating a potential user of an electronic device having a facial recognition security system (e.g., a facial recognition security system with a camera module, a light source, and control circuitry for operating the camera module and the light source).

At step 120, the facial recognition security system in the electronic device may be activated.

At step 122, the facial recognition security system may be used to determine whether the face of the potential user of the device to be recognized is a planar object such as photograph of a face or an object having protruding features such as a human face.

At step 124, in response to determining that the face to be recognized is not a photograph of a face, the facial recognition security system may perform additional facial recognition security operations such as comparing stored facial information associated with authorized users of the device with facial information associated with the face to be recognized.

At step 126, in response to determining that the face to be recognized is a photograph of a face, the facial recognition security system may take appropriate action for a security verification failure. Appropriate action for a security verification failure may include displaying a security verification failure notice to the potential user on a display, activating a security alarm system or alert system, or performing additional security verification operations (e.g., finger print security verification operations, pass-code entry security verification operations or other supplemental security verification operations).

Various embodiments have been described illustrating an electronic device having a camera module and at least one light source configured to capture images and extract topological information from the captured images. The electronic device may include a display, control circuitry and one or more light sources. The light sources may include the display, portions of the display, light-emitting-diodes, lamps, light-bulbs, or other light sources. The light sources may be mounted in a bezel portion of a housing that surrounds the display. The light sources may include two light sources mounted in the bezel that surrounds the display. The light sources may be configured to illuminate an object or objects to be imaged using the camera module from one or more illumination angles in order to generate changing shadow patterns on the object.

During security verification or depth mapping operations, an image may be captured with all light sources in the device inactivated (i.e., turned off). One or more additional images may be captured while operating one or more light sources. For example, a single additional image may be captured while operating a single light source, a single image may be captured while operating multiple light sources, multiple additional images may be captured while operating multiple light sources or multiple additional images may be captured while operating a single light source.

These image capture operations described above may be used as a portion of a security verification operation such as a facial recognition security verification operation that uses facial recognition in images as a user authentication tool. If desired, prior to performing facial recognition operations on captured images, images captured using the camera module and the light source(s) may be used to determine whether the face being imaged is a two-dimensional photograph of a face or a three-dimensional face.

The foregoing is merely illustrative of the principles of this invention which can be practiced in other embodiments.

What is claimed is:

1. A method for authenticating a user of an electronic device having a camera module and a light source, comprising:
with the camera module, capturing a first image of the user;
operating the light source;
with the camera module, while operating the light source, capturing a second image of the user; and
determining whether the user is an authorized user using the first image and the second image.

2. The method defined in claim 1 wherein determining whether the user is an authorized user using the first image and the second image comprises:
extracting shaded portions of the first image;
extracting shaded portions of the second image; and
determining whether the shaded portions of the first image are different from the shaded portions of the second image.

3. The method defined in claim 2, further comprising:
in response to determining that the shaded portions of the first image are different from the shaded portions of the second image, performing facial recognition operations.

4. The method defined in claim 3 wherein performing the facial recognition operations comprises:
determining whether a face in the first image of the user is the face of an authorized user of the device.

5. The method defined in claim 4 wherein determining whether the face in the first image of the user is the face of the authorized user of the device comprises:
accessing facial information associated with authorized users of the device that is stored in the electronic device; and
comparing the face in the first image to the accessed facial information.

6. The method defined in claim 2, further comprising:
in response to determining that the shaded portions of the first image are not different from the shaded portions of the second image, providing a security verification failure notification.

7. The method defined in claim 6 wherein the electronic device includes a display and wherein providing the security verification failure notification comprises providing the security verification failure notification using the display.

8. The method defined in claim 2 wherein the light source includes a display and wherein operating the light source comprises:
activating a first portion of the display; and
while activating the first portion of the display, inactivating a second portion of the display.

9. The method defined in claim 2 wherein the electronic device includes an additional light source, the method further comprising:
operating the additional light source; and
with the camera module, while operating the additional light source, capturing a third image of the user, wherein determining whether the user is the authorized user using the first image and the second image comprises determining whether the user is the authorized user using the first image, the second image, and the third image.

10. A method for generating a depth image of a scene using an electronic device having an image sensor and a light source, comprising:
capturing a first image of the scene using the image sensor;
illuminating the scene using the light source;
capturing a second image of the scene using the image sensor while illuminating the scene using the light source;
extracting shadow information from the first image and shadow information from the second image;
comparing the shadow information from the first image with the shadow information from the second image; and
extracting depth information associated with distances to surfaces of objects in the scene using the comparison of the shadow information from the first image with the shadow information from the second image.

11. The method defined in claim 10, further comprising:
illuminating the scene using an additional light source; and
capturing a third image of the scene using the image sensor while illuminating the scene using the additional light source.

12. The method defined in claim 11, further comprising:
extracting shadow information from the third image.

13. The method defined in claim 12, further comprising:
comparing the shadow information from the third image with the shadow information from the first image and the shadow information from the second image; and
extracting additional depth information associated with the distances to the surfaces of the objects in the scene using the comparison of the shadow information from the third image with the shadow information from the first image and the shadow information from the second image.

14. The method defined in claim 13, further comprising:
generating the depth map using the extracted depth information and the extracted additional depth information.

15. A facial recognition security verification system, comprising;
a housing having a bezel portion;
a camera module mounted in the bezel portion;
a plurality of light sources; and
control circuitry for operating the camera module and the plurality light sources, wherein the control circuitry is configured to operate the plurality of light sources to generate changing shadow distributions on a face and to capture a plurality of images of the face while generating the changing shadow distributions on the face and wherein the control circuitry is configured to determine whether the face in the captured plurality of images is a planar object or an object having protruding features using the plurality of images that were captured while generating the changing shadow distributions on the face.

16. The security system defined in claim 15 wherein the plurality of light sources comprise:
a display; and
an additional light source mounted in the bezel portion of the housing.

17. The security system defined in claim 15 wherein the plurality of light sources comprises first and second light sources mounted in the bezel portion of the housing.

18. The security system defined in claim 17 wherein the first and second light sources comprise first and second light-emitting diodes.

19. The security system defined in claim 15 wherein the plurality of light sources comprises at least first and second portions of a display and wherein the control circuitry is configured to operate the camera module and the first and second portions of the display to capture a first image while operating the first portion of the display and to capture a second image while operating the second portion of the display.

20. The security system defined in claim 15 wherein the plurality of light sources comprises at least one light source configured to emit near-infrared light and wherein the camera module comprises at least one image sensor configured to receive near-infrared light.
